(19) United States
(12) Patent Application Publication
(10) Pub. No.: US 2026/0108338 A1
(43) Pub. Date: Apr. 23, 2026

(54) ELECTRIC TOOTHBRUSH AND MOTOR THEREOF

(71) Applicant: GUANGZHOU STARS PULSE CO.,LTD., GUANGZHOU (CN)

(72) Inventors: MENG WANG, GUANGZHOU (CN); KE LIU, GUANGZHOU (CN); YAGUI LI, GUANGZHOU (CN); SHOUMIN ZHU, GUANGZHOU (CN)

(21) Appl. No.: 19/367,108

(22) Filed: Oct. 23, 2025

(30) Foreign Application Priority Data
Oct. 23, 2024 (CN) 202422569679.8
Sep. 12, 2025 (CN) 202511310874.1

(51) Int. Cl. A61C 17/34; A46B 13/02; H02K 33/16

(52) U.S. Cl. CPC A61C 17/3481; A46B 13/023; H02K 33/16

(57) ABSTRACT

An electric toothbrush and a motor thereof are provided. The motor includes a motor housing, a stator assembly fixedly disposed in the motor housing, and a rotor assembly. The stator assembly comprises a stator core. The rotor assembly is disposed in a mounting cavity of the stator assembly. The rotor assembly includes a rotor core, permanent magnets and protruding portions. The permanent magnets are disposed at intervals in a circumferential direction of the rotor core. At least one group of protruding portions is disposed between corresponding two adjacent permanent magnets. The at least one group of protruding portions extends from a surface of the rotor core. A distance between an end surface of each of the protruding portions and the central axis of the rotor core is greater than a distance between an outer surface of each of the permanent magnets and the central axis of the rotor core.

### TECHNICAL FIELD

The present disclosure relates to a technical field of electric toothbrushes, and in particular to an electric toothbrush and a motor thereof.

### BACKGROUND

Electric toothbrushes automatically vibrate to clean teeth, offering high cleaning frequency, time savings, and effort-saving features, making the electric toothbrushes popular with users.

A motor of a conventional electric toothbrush generally defines a limited rotational space for a rotor assembly thereof to prevent a rotor thereof from swinging significantly in a circumferential direction thereof. Consequently, the rotor is only allowed to vibrate at a high frequency to drive a brush head of the conventional electric toothbrush to vibrate, so as to achieve a desired cleaning function. However, the rotor is unable to drive the brush head to swing to clean teeth. Therefore, if a user does not move the conventional electric toothbrush during oral cleaning, a coverage area of the brush head is limited, resulting in a high probability of missing certain areas of the teeth during cleaning and resulting in a poor cleaning result. Even though the user is able to achieve a better cleaning result by moving the conventional electric toothbrush, it requires the user to constantly adjust a position of the brush head on the teeth, which is laborious and time-consuming.

Furthermore, the motor of the conventional electric toothbrush commonly comprises limiting pieces mounted on permanent magnet sleeves thereof, and the limiting pieces cooperate with a stator to limit a position of a rotor. However, during a limiting process, when the limiting pieces hit the stator, the limiting pieces on the permanent magnet sleeves are likely to fall off, resulting in limiting failure. In addition, assembly cost is high when the limiting pieces are disposed on the permanent magnet sleeves.

### SUMMARY

In view of this, the present disclosure provides a motor of an electric toothbrush and the electric toothbrush.

In a first aspect, the present disclosure provides the motor of the electric toothbrush. The motor comprises a motor housing, a stator assembly fixedly disposed in the motor housing, and a rotor assembly. The stator assembly comprises a stator core. The rotor assembly is disposed in a mounting cavity of the stator assembly. The rotor assembly comprises a rotor core, permanent magnets and at least one protruding portion. The permanent magnets are disposed at intervals in a circumferential direction of the rotor core.

In a second aspect, the present disclosure provides the electric toothbrush. The electric toothbrush comprises a cleaning element and the motor described above.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a schematic diagram of a motor of an electric toothbrush of the present disclosure.

FIG. 2 is an exploded schematic diagram of the motor according to a first embodiment of the present disclosure.

FIG. 3 is an exploded schematic diagram of the motor according to a second embodiment of the present disclosure, where permanent magnet sleeves are removed.

FIG. 4 is a partial exploded schematic diagram of the motor according to the first embodiment of the present disclosure.

FIG. 5 is another exploded schematic diagram of the motor according to the second embodiment of the present disclosure, where the permanent magnet sleeves are removed.

FIG. 6 is a cross-sectional schematic diagram of the motor according to the first embodiment of the present disclosure.

FIG. 7 is a cross-sectional schematic diagram of the motor according to the second embodiment of the present disclosure.

FIG. 8 is a cross-sectional schematic diagram of the motor according to a third embodiment of the present disclosure.

FIG. 9 is an exploded schematic diagram of the motor according to the third embodiment of the present disclosure.

FIG. 10 is a partial exploded schematic diagram of the motor according to the third embodiment of the present disclosure.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

In the absence of conflict, the following embodiments and features thereof may be combined with each other.

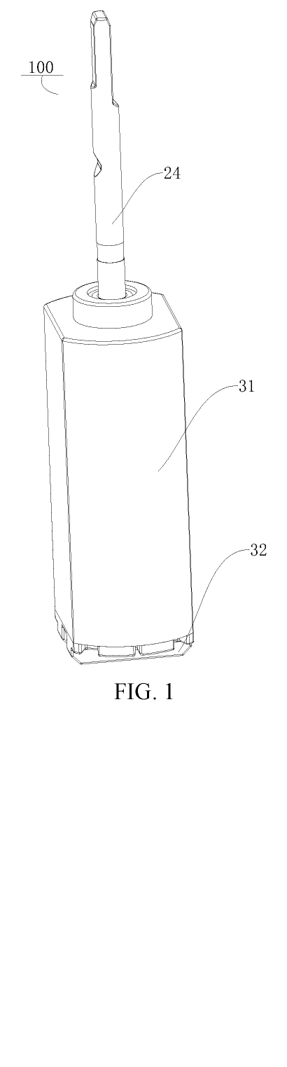

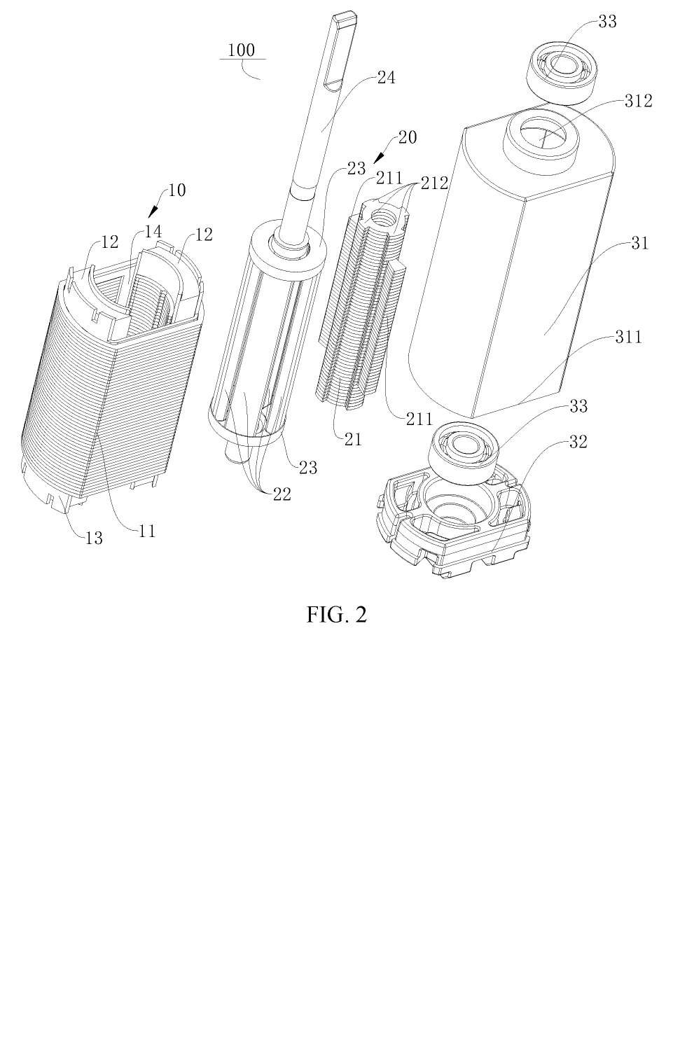

As shown in FIGS. 1 and 2, one embodiment of the present disclosure provides a motor 100 of an electric toothbrush. The motor 100 is disposed inside the electric toothbrush to provide power required for vibration and swinging of a cleaning element, thereby enabling the cleaning element to effectively clean teeth. The cleaning element is a brush head.

As shown in FIGS. 2-5 and 9-10, the motor 100 of the electric toothbrush comprises a motor housing 31, a stator assembly 10 and a rotor assembly 20. The stator assembly 10 is fixedly mounted in the motor housing 31.

As shown in FIGS. 2, 3, and 9, the stator assembly 10 comprises a stator core 11. The stator core 11 is a stator iron core 11. The rotor assembly 20 is disposed in a mounting cavity 14 of the stator assembly 10. The rotor assembly 20 comprises a rotor core 21, permanent magnets 22 and at least one protruding portion 211. The rotor core 21 is a rotor iron core. The permanent magnets 22 are disposed at intervals in a circumferential direction of the rotor core 21. The permanent magnets 22 and the rotor core 21 are rotatable together relative to the stator assembly 10, thereby forming a magnetic field with a certain magnetic field strength. In the description of the present disclosure, "plurality" means two or more, unless otherwise specifically defined.

The at least one protruding portion 211 comprises one or more protruding portions 211. When only one protruding portion 211 is provided, the at least one protruding portion 211 is a protrusion disposed on an outer surface of the rotor core 21.

Furthermore, as shown in FIGS. 2, 3, and 9, when the at least one protruding portion 211 comprises the protruding portions 211, at least one group of protruding portions 211 is disposed on a surface of the rotor core 21. That is, there may be one group, two groups, or more groups of protruding portions 211. The at least one group of protruding portions 211 is disposed between corresponding two adjacent permanent magnets 22. In other words, the at least one group of protruding portions 211 is disposed in a position sandwiched by the corresponding two adjacent permanent magnets 22, or the at least one group of protruding portions 211 is disposed at a position between and below the corresponding two adjacent permanent magnets 22. Alternatively, the at least one group of protruding portions 211 is disposed at a position between and above the corresponding two adjacent permanent magnets 22.

Each group of protruding portions 211 extends from the surface of the rotor core 21 in a direction away from a central axis of the rotor core 21. A distance between an end surface of each of the protruding portions 211 facing the stator core 11 and the central axis of the rotor core 21 is greater than a distance between an outer surface of each of the permanent magnets 22 and the central axis of the rotor core 21. Namely, the end surface of each of the protruding portions 211 facing the stator core 11 is not coplanar with the outer surface of each of the permanent magnets 22 facing the stator core 11, and the end surface of each of the protruding portions 211 facing the stator core 11 is closer to an inner surface of the rotor core 21 than the outer surface of each of the permanent magnets 22 facing the stator core 11.

As can be seen from the above technical solution, in the motor of the present disclosure, the motor housing 31 effectively protects the stator assembly 10 disposed therein and the rotor assembly 20 disposed therein. The motor housing 31 enables the motor into an overall compact module, which is easy to assemble, repair, and replace.

By providing the protruding portions 211 on the rotor assembly 20, during rotation of the rotor core 21, the protruding portions 211 are able to abut against the stator assembly 10, such as abutting against the stator core 11 or abutting against surfaces of the winding brackets 13 of the stator assembly 10. Thus, a variety of possible abutment and limiting fits between the protruding portions 211 and the stator assembly 10 is achieved, and an area with a larger abutment and limiting fit angle is selected to enable the rotor assembly 20 to have a greater rotation angle relative to the stator assembly 10. When the protruding portions 211 abut against and fit with the stator core 11, since the stator assembly 10 is fixed relative to the motor housing 31, and the protruding portions 211 are fixed relative to the rotor core 21, during the rotation of the rotor assembly 20 relative to the stator assembly 10, the protruding portions 211 are more stable by forming a limited fit with the stator core 21, so that the stator core 11 provides reliable support and mechanical limit for the rotation of the rotor assembly 20, and the abutment stability is good. As a result, the rotor assembly 20 rotates stably within a predetermined range relative to the stator assembly 10, and a limiting cooperation between the protruding portions 211 and the stator assembly 10 limits the rotation of the rotor assembly 20 to the predetermined range, which is conducive to the rotor assembly 20 being able to stop in an area with larger magnetic resistance of the magnetic field and avoiding the rotor assembly 20 staying in an area with smaller magnetic resistance of the magnetic field. In this way, the rotor assembly 20 is enabled to respond quickly and rotate relative to the stator assembly 10, and a low-speed jitter of the rotor assembly 20 during rotation is reduced.

Because components of the stator assembly 10 of the present disclosure, such as the stator core 11, have a relatively large inner surface, the rotor core 21 is rotatable within a wide angular range relative to the stator core 11. The wide and stable rotation of the rotor core 21 improves a torsional resistance of the motor 100.

It is understood that a motor of a conventional electric toothbrush commonly comprises limiting pieces respectively mounted on permanent magnet sleeves thereof, and the limiting pieces cooperate with a stator to limit positions of the permanent magnet sleeves. However, during a limiting process, when the limiting pieces hit the stator, the limiting pieces on the permanent magnet sleeves are likely to fall off, resulting in limiting failure. In addition, assembly cost is high when the limiting pieces are one-to-onedisposed on the permanent magnet sleeves. Compared to the prior art, the protruding portions 211 are disposed on the rotor core 21 of the present disclosure, and the stator assembly 10 is matched with the protruding portions 211 for positional restraint. Therefore, during the rotation of the rotor assembly 20, the positional restraint of the protruding portions 211 with the stator assembly 10, such as the stator core 11, does not affect arrangement stability of permanent magnet sleeves 23 of the present disclosure. Therefore, there is no need to set a limiting structure on each of the permanent magnet sleeves 23, and the permanent magnet sleeves 23 are easy to assemble, thereby facilitating the assembly of the motor 100, reducing the assembly cost, and improving limiting stability during the rotation of the rotor assembly 20.

The rotor assembly in the prior art has a limited rotational space, preventing large circumferential swing and only enabling small-angle and high-frequency vibrations, which results in a small cleaning area and a low cleaning rate. Compared to the prior art, the motor 100 of the electric toothbrush of the present disclosure is able to drive the cleaning element to swing at a large angle, which makes cleaning more effective and achieves high-efficiency and large-area cleaning.

In some embodiments of the present disclosure, the rotor core 21 comprises a plurality of silicon steel sheets, and each of the protruding portions 211 is composed of at least one of the silicon steel sheets that extends from the surface of the rotor core 21 toward the direction away from the central axis of the rotor core 21. By adopting the rotor core 21 including the plurality of silicon steel sheets, eddy current losses during the rotation of the rotor assembly 20 are reduced. It is noted that not all of the silicon steel sheets are provided with the protruding portions. When only one protruding portion is provided, the one protruding portion is disposed on any one of the silicon steel sheets. Alternatively, when two protruding portions are provided, the two protruding portions may be disposed on one of the silicon steel sheets, or the two protruding portions are disposed on any two of the silicon steel sheets. In this case, the two protruding portions are optionally symmetrically disposed. When more than two protruding portions are provided, arrangements thereof may refer to the arrangements of the one or two protruding portions, which are not limited thereto.

In some embodiments, as shown in FIGS. 2, 3, and 9, the permanent magnets 22 are evenly disposed in the circumferential direction of the rotor core 21. In this way, when the rotor assembly 20 is moved by a magnetic field force, a force in a circumferential direction of the rotor assembly 20 is uniform, and a vibration effect of the cleaning element is good, thereby improving cleaning ability of the cleaning element.

Furthermore, each group of protruding portions 211 extends along an axial direction of the rotor core 21. That is, a length direction of the protruding portions 211 is consistent with the axial direction of the rotor core 21. A length of each group of protruding portions 211 along the axial direction of the rotor core 21 is not greater than a length of each of the permanent magnets 22 along the axial direction of the rotor core 21.

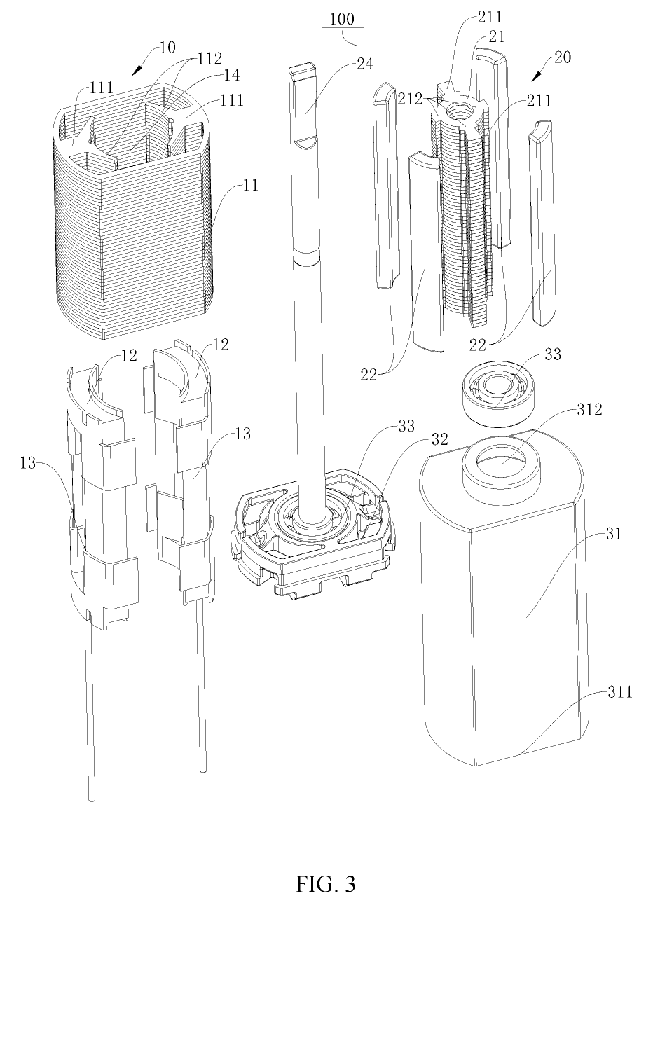

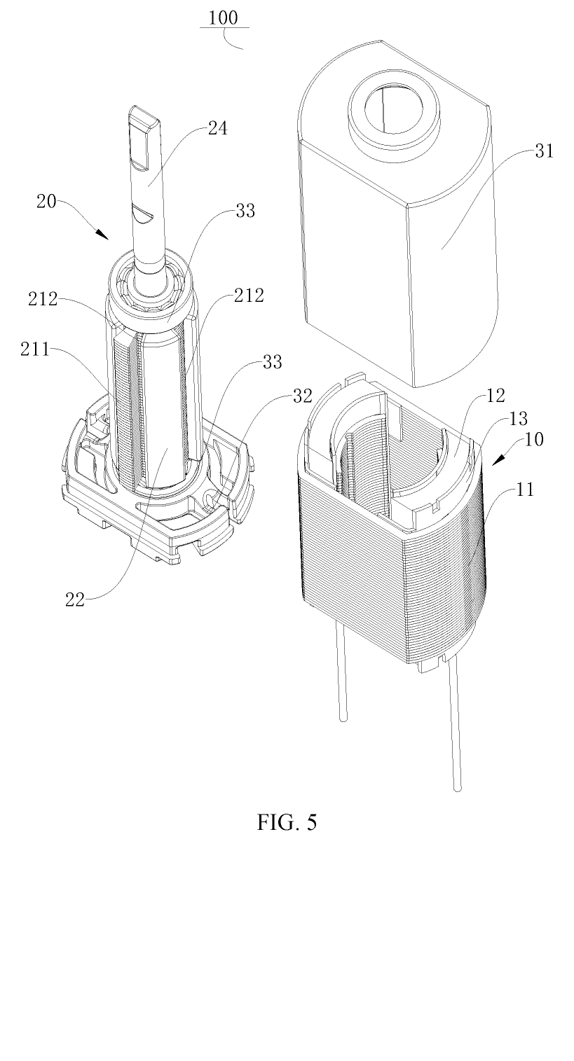

Then, as shown in FIGS. 3 and 5, the length of each group of protruding portions 211 is equal to the axial length of the rotor core 21. Alternatively, as shown in FIGS. 2, 4, 9, and 10, the length of each group of protruding portions 211 is a certain proportion of the axial length of the rotor core 21. The length of each group of protruding portions 211 is selectively set according to actual conditions to ensure that the length of each group of protruding portions 211 is configured reasonably. On the one hand, each group of protruding portions 211 is able to form a large contact surface with the stator core 11, which improves a mechanical limiting effect of each group of protruding portions 211 and the stator core 11, thereby forming a stable limiting structure and ensuring stable swinging of the rotor assembly 20 relative to the stator assembly 10. On the other hand, considering manufacturing costs, the length of each group of protruding portions 211 is determined to enable a low cost while ensuring stable contact of the protruding portions 21 with the stator core 11.

In some embodiments, a ratio of the length of each group of protruding portions 211 along the axial direction of the rotor core 21 to the axial length of the rotor core 21 is 30% to 90%, which ensures low-cost manufacturing and stable contact with the stator core 11 over a large area. For instance, in some embodiments, the length of each group of protruding portions 211 accounts for 30%, 35%, 40%, 45%, 50%, 55%, 60%, 65%, 70%, 75%, 80%, 85%, or 90% of the axial length of the rotor core 21. If the ratio of the length of each group of protruding portions 211 to the axial length of the rotor core 21 is less than 30%, the contact area between each group of protruding portions 211 and the inner surface of the stator core 11 is too small, resulting in poor contact and collision. When the ratio of the length of each group of protruding portions 211 to the axial length of the rotor core 21 exceeds 90%, the cost of providing the protruding portions 211 is high, hindering cost control and hindering a placement of other components, such as the permanent magnet sleeves 23 disposed on two ends of the rotor core 21. By limiting the ratio of the length of each group of protruding portions 211 to the axial length of the rotor core 21 to between 30% and 90%, not only does the ratio ensure sufficient contact area between each group of protruding portions 211 and the inner surface of the stator core 11, but it also achieves reasonable cost control, saves material, and reduces a space required for the protruding portions 211.

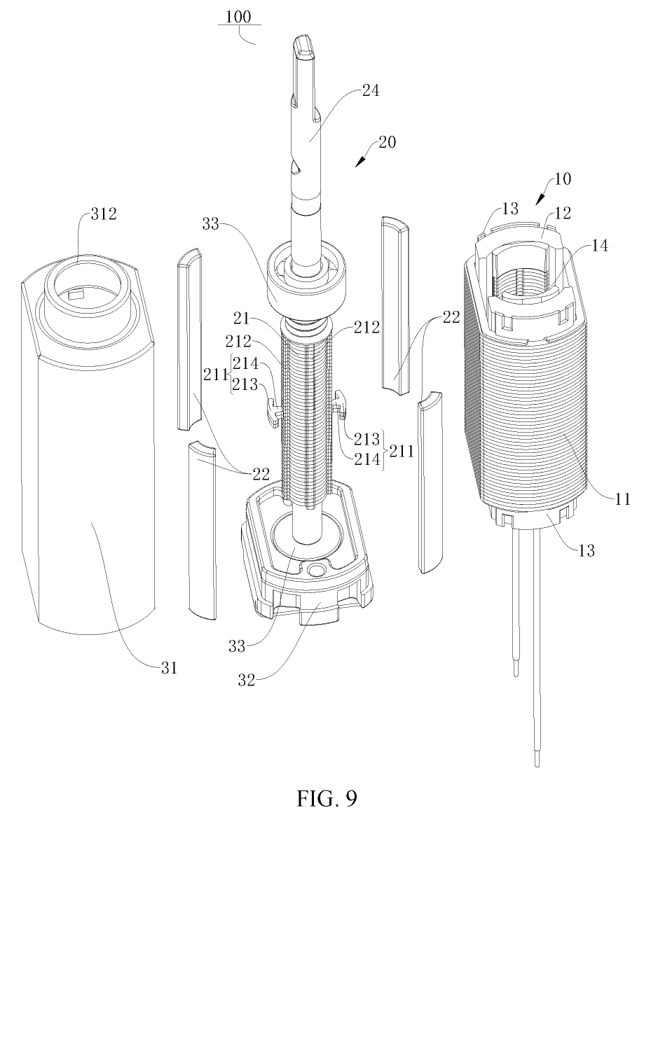

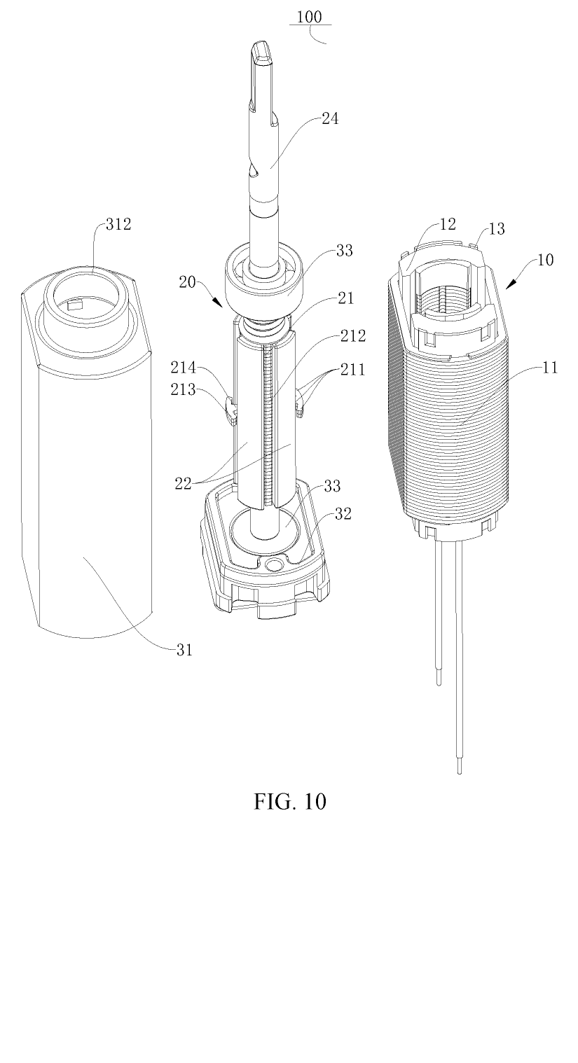

Of course, the ratio of the length of each group of protruding portions 211 to the axial length of the rotor core 21 in the present disclosure may be outside the above range; and an appropriate ratio is selected based on actual needs. In other embodiments, as shown in FIGS. 9 and 10, the ratio of the length of each group of protruding portions 211 along the axial direction of the rotor core 21 to the axial length of the rotor core 21 is less than 30%. Therefore, under a premise of ensuring stable positioning of each group of protruding portions 211 and the stator core 11, the arrangement space and additional cost of each group of protruding portions 211 is saved, and an influence of a configuration of the protruding portions 211 on a magnetic circuit is reduced.

In some embodiments, each group of protruding portions 211 disposed between corresponding two adjacent permanent magnets 22 comprises at least two protruding portions 211 disposed at intervals, so that more positions in the axial direction of the rotor core 21 are allowed to abut against the stator core 11 through the protruding portions 211, and the force in the axial direction of the rotor core 21 is more uniform and more synchronous when the rotor core 21 rotates.

In some embodiments, as shown in FIGS. 2, 4, 9, and 10, when the length of each group of protruding portions 211 along the axial direction of the rotor core 21 is less than the length of each of the permanent magnets 22 along the axial direction of the rotor core 21, a midpoint of the at least one group of protruding portions 211 along the axial direction of the rotor core 21 coincides with a midpoint of the rotor core 21 along the axial direction. Therefore, each group of the protruding portions 211 is disposed in a gap defined by the corresponding two adjacent permanent magnets at a middle position relative to the axial direction of the rotor core 21. In other words, a vertical distance between a first end of each group of protruding portions 211 in the vertical direction and a first axial end surface of the rotor core 21 is equal to a vertical distance between a second end of each group of protruding portions 211 in the vertical direction and a second axial end surface of the rotor core 21, which makes a gravity center of the rotor core 21 centered and prevents the rotor core 21 from deviating from the gravity center thereof due to the configuration of the protruding portions 211. It is understood that the cost of the protruding portions 211 of the rotor core 21 of the embodiments of the present disclosure is effectively controlled, and the rotor core 21 is able to abut against corresponding portions of the stator core 11 through the protruding portions 211, so that the rotor core 21 rotates to a maximum angle and then rotates back. The rotor assembly 20 rotates stably during a rotation process.

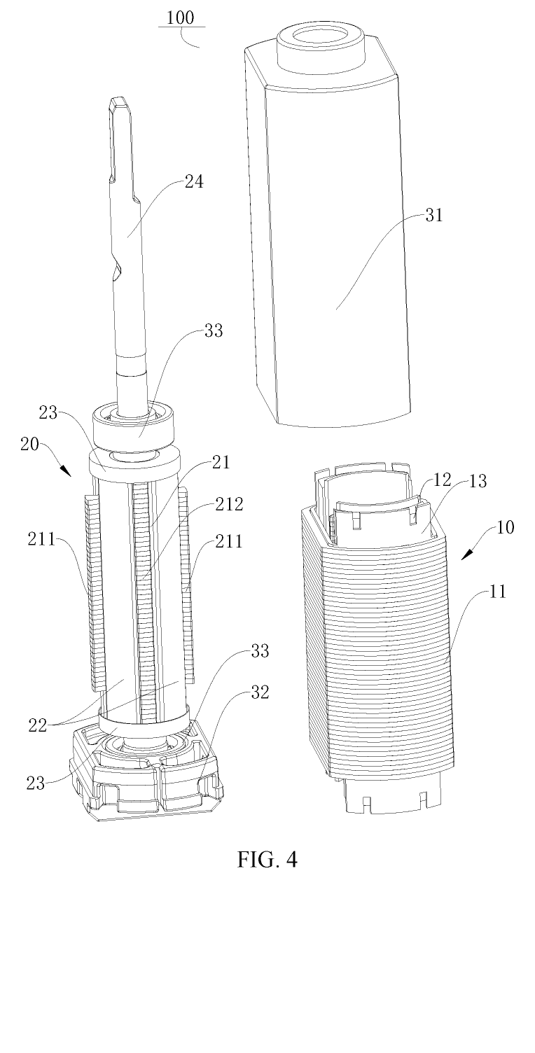

In some embodiments, as shown in FIGS. 4-8 and 10, the permanent magnets 22 comprise four permanent magnets 22 evenly disposed at equal angles along the circumferential direction of the rotor core 21. The at least one group of protruding portions 211 comprises two groups of protruding portions 211, and each group of the protruding portions 211 is disposed between the corresponding two adjacent permanent magnets 22 of the four permanent magnets 22. That is, the four permanent magnets 22 are evenly disposed around a circumferential direction of the rotor core 21, and the gap is defined between each two adjacent permanent magnets 22. Namely, four gaps are formed, and the four gaps are also evenly spaced around the circumferential direction of the rotor core 21. Simultaneously, the two groups of protruding portions 211 are positioned in two symmetrical gaps of the four gaps, ensuring that the two groups of protruding portions 211 are symmetrically disposed relative to a center plane of the rotor core 21. Such an arrangement not only increases a magnetic flux of the rotor assembly 20 but also ensures two abutment surfaces between the rotor core 21 and the stator core 11. When the rotor assembly 20 moves relative to the stator assembly 10, the rotor assembly 20 is stably rotatable 180 degrees. Thus, a motion range of the cleaning element driven by the motor 100 for automatic cleaning teeth is controlled within a reasonable range.

In some embodiments, as shown in FIGS. 2 and 4, the rotor assembly 20 further comprises two permanent magnet sleeves 23. The two permanent magnet sleeves 23 are mounted at two ends of the rotor core 21. Two ends of each of the permanent magnets 22 are limited within the two permanent magnet sleeves 23. In these embodiments, the two permanent magnet sleeves 23 further limit axial positions of the permanent magnets 22, allowing the permanent magnets 22 to rotate with the rotor core 21 during high-speed rotation. The two permanent magnet sleeves 23 limit the positions of the permanent magnets 222, which ensures that the permanent magnets 22 maintain a stable relative position relative to the rotor core 21, thereby effectively preventing the permanent magnets 22 from falling out and potentially causing motor 100 failure.

In some embodiments, as shown in FIGS. 2 and 4, the rotor assembly 20 further comprises a rotating shaft 24, and the two permanent magnet sleeves 23 are mounted on two ends of the rotating shaft 24. The two permanent magnet sleeves 23 respectively limit two axial end surfaces of each of the permanent magnets 22.

In some embodiments, the two permanent magnet sleeves 23 and the permanent magnets 22 form an interference fit, so that the permanent magnets 22 are positioned. Alternatively, the permanent magnet sleeves 23 define limiting grooves, and the permanent magnets 22 are limited in the limiting grooves for positioning. Specific arrangements of the permanent magnets 22 and the permanent magnet sleeves 23 in the present disclosure are not limited to the aforementioned arrangements; other limiting arrangements may be employed according to specific circumstances.

In some embodiments, the two ends of each group of protruding portions 211 along the axial direction of the rotor core 21 are respectively spaced apart from the two permanent magnet sleeves 23, which ensures that each group of protruding portions 211 does not extend into the two permanent magnet sleeve s23, but is only disposed outside of the two permanent magnet sleeves 23, thereby preventing the two permanent magnet sleeves 23 from falling off during the process of the rotor core 21 abutting and colliding with the stator core 11. Therefore, the two permanent magnet sleeves 23 protect the permanent magnets 22 well. The embodiments may correspond to the aforementioned embodiments where the length of each group of protruding portions 211 accounts for 60% to 90% of the axial length of the rotor core 21. In the embodiments, the arrangement of the rotor core 21 leaves sufficient space at the two ends thereof to mount the two permanent magnet sleeves 23, thereby effectively preventing the permanent magnets 22 from falling off during the high-speed rotation of the rotor core 21.

Alternatively, the two ends of each group of protruding portions 211 along the axial direction of the rotor core 21 are clearance-fitted with the two permanent magnet sleeves 23, which ensures that each group of protruding portions 211 does not contact the two permanent magnet sleeves 23 and ensures that the two permanent magnet sleeves 23 do not fall off during the collision between each group of protruding portions 211 and the stator core 11. Furthermore, the contact area between each group of protruding portions 211 and the stator core 11 is sufficiently large, ensuring stability during the abutment and enabling the rotor core 21 to rotate smoothly when the rotor core 21 reaches a maximum angle thereof. The arrangements of the protruding portions 211 and the stator core 11 achieve mechanical circumferential limitation of the rotor core 21 relative to the stator core 11. When the rotor core 21 abuts against the stator core 11, a holding force is large and the torsional resistance is high. The embodiments herein may correspond to the embodiments where the length of each group of protruding portions 211 is equal to the axial length of the rotor core 21, thereby achieving a large-area abutment between the corresponding portions of the rotor core 21 and the stator core 11 and achieving excellent torsional resistance.

In some embodiments, as shown in FIGS. 2-10, the stator assembly 10 further comprises two groups of coils 12. Two winding arms 111 are respectively disposed on opposite sides of the inner surface of the stator core 11. The two winding arms 111 are one-to-one wound around the two groups of coils 12. The protruding portions 211 extend toward the inner surface of the stator core 11 between the two winding arms 111. When the rotor core 21 rotates to a maximum angle, each of the protruding portions 211 abuts against a corresponding one of the winding arms 111. When energized, the two groups of coils 12 generate a variable magnetic field, thereby generating an electromotive force within the stator assembly 10 within the magnetic field. The rotor assembly 20, within an electromagnetic field (the magnetic field), is driven to rotate by the stator assembly 10. The rotor assembly 20 is rotatable stably relative to the stator assembly 10. During rotation, when the rotor core 21 rotates until the protruding portions 211 contact the two winding arms 111, the rotor core 21 is rotated to the maximum angle. The protruding portions 211 are rotatable within the stator core 11 between the two winding arms 111. During rotation, the rotor assembly 20 does not collide with the winding brackets 13 or the two groups of coils 12. An internal space within the stator core 11 between the two winding arms 111 is sufficiently large, allowing the rotor assembly 20 to rotate over a wide range. Therefore, the rotor assembly 20 is able to stably output an electric torque capable of large-angle swing, enabling the motor 100 to vibrate and swing the cleaning element. It is understood that the two winding arms 111 limit a circumferential rotation angle of the rotor assembly 20.

In some embodiments, as shown in FIGS. 3, 6, and 7, each of the winding arms 111 comprises a support portion 112. A surface of each support portion 112 is matched with the outer surface of each of the permanent magnets 22. That is, each support portion 112 thereof is bent and recessed towards one side of the rotor core 21, so that when the rotor assembly 20 rotates, each support portion 112 radially limits the permanent magnets 22 of the rotor assembly 20 to a certain extent. Each support portion 112 is configured to limit a maximum radial displacement of each of the permanent magnets 22 during rotation. That is, when the rotor assembly 20 rotates, the protruding portions 211 rotate relative to the stator core 11, and each support portion 112 supports a corresponding one of the permanent magnets 22, so that the permanent magnets 22 rotate evenly along the circumferential direction of the rotor assembly 20. Two ends of each support portion 112 are further configured to limit the maximum radial displacement of each of the permanent magnets 22 when the permanent magnets 22 rotate. The arrangement of each support portion 112 further increases the magnetic flux of the stator core 11, thereby improving performance of the motor 100.

In some embodiments, the two winding arms 111 are symmetrically disposed with a central plane of the stator core 11 as a symmetry plane, so that an entire structure of the stator core 11 is subjected to uniform force.

In some embodiments, as shown in FIGS. 2, 3, and 9, the stator assembly 10 further comprises two winding brackets 13. The two winding brackets 13 are respectively disposed on the two winding arms 111 of the stator core 1, and ends of the two groups of coils 12 are respectively wound on the two winding brackets 13. The two winding brackets 13 respectively support the two winding arms 111 within the stator core 11, thereby improving structural stability. The two winding brackets 13 further provide space for winding the two groups of coils 12, thereby improving the magnetic flux of the stator assembly 10.

In some embodiments, the two winding brackets 13 are symmetrically disposed with the central plane of the stator core 11 as a symmetry plane, so that the entire structure of the stator core 11 is subjected to uniform force.

In some embodiments, the two winding brackets 13 comprise guide pins or guide wires that are respectively connected to the two groups of coils 12, thereby enabling the two groups of coils 12 to be connected to an external power source for power supply. Alternatively, the two groups of coils 12 are connected to an external control board to control a current in the two groups of coils 12, thereby adjusting the electromagnetic field of the stator core 11.

In some embodiments, as shown in FIGS. 3, 5 and 10, the two winding brackets 13 need to be fixed to the stator core 11. Therefore, the two winding brackets 13 extend beyond the stator core 11 in the axial direction. In the embodiments, the two groups of protruding portions 211 respectively abut against the two winding brackets 13. Since the two winding brackets 13 are fixed relative to the stator core 11, the two winding brackets 13 provide stable limiting for the two groups of protruding portions 211 during a process of the two groups of protruding portions 211 colliding with the two winding brackets 13. The two groups of protruding portions 211 respectively abut against the two winding brackets 13 for limiting, which increases optional parts of a limiting cooperation between the two groups of protruding portions 211 and the stator assembly 10.

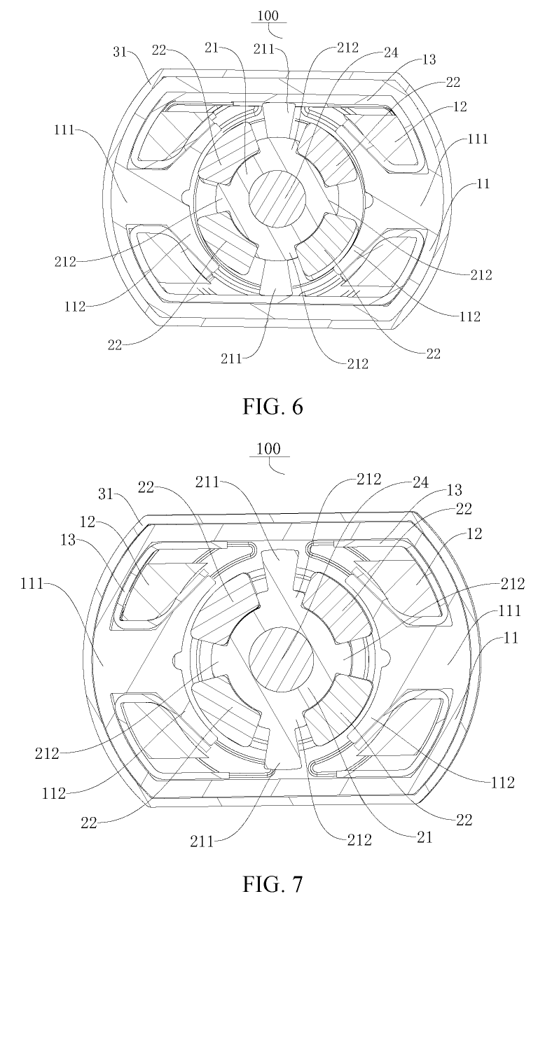

In some embodiments, as shown in FIGS. 6-8, surfaces of the protruding portions 211 are spaced apart from surfaces of the permanent magnets 22. The surfaces of the protruding portions 211 refer to outer surfaces thereof. The outer surfaces of the protruding portions 211 do not contact the rotor core 21. The surfaces of the permanent magnets 22 refer to outer surfaces thereof. The outer surfaces of the permanent magnets 22 do not contact the rotor core 21 either. Part of the outer surface of each group of protruding portions 211 and parts of the outer surfaces of the corresponding two adjacent permanent magnets 22 are spaced apart, so that the outer surface of each group of protruding portions 211 does not contact the outer surfaces of the corresponding two adjacent permanent magnets 22. Alternatively, part of the outer surface of each group of protruding portions 211 and the parts of the outer surfaces of the corresponding two adjacent permanent magnets 22 are staggered, so that each group of protruding portions 211 and the corresponding two adjacent permanent magnets 22 are spaced apart and do not contact each other. Then, it is understood that the protruding portions 211 themselves do not contact the permanent magnets 22, which effectively prevents the protruding portions 211 from colliding with the permanent magnets 22 during the abutment and collision with the stator core 11, thereby preventing the permanent magnets 22 from falling off.

In some embodiments, a structure and a shape of each of the protruding portions 211 are flexibly configured as needed. Each of the protruding portions 211 may be a single component extending substantially parallel to the radial direction of the rotor core 21. Alternatively, each of the protruding portions 211 may be composed of a plurality of components, such as a component extending substantially parallel to the radial direction of the rotor core 21 and a component disposed at an angle to the radial direction of the rotor core 21.

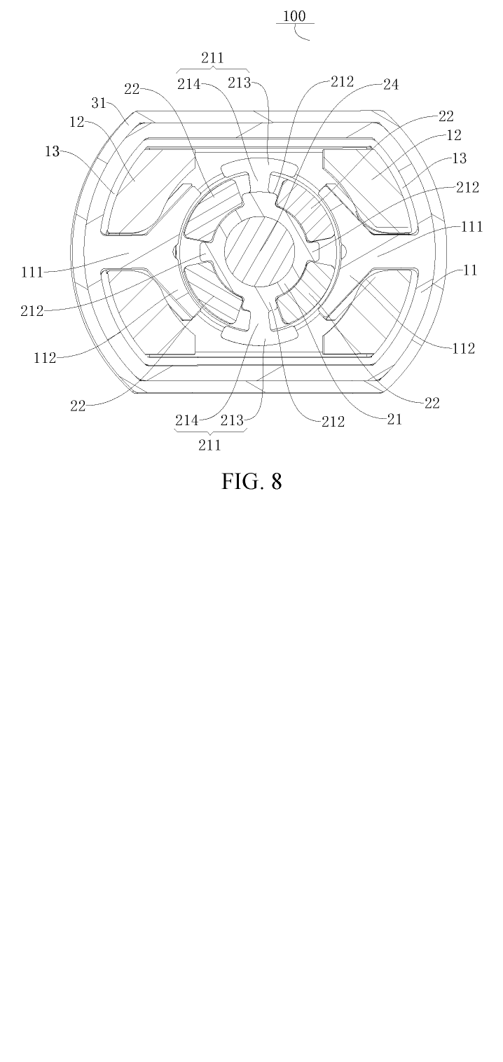

In some embodiments, as shown in FIGS. 8-10, each of the protruding portions 211 comprises a stop portion 213 and a connecting portion 214; one end of the connecting portion 214 thereof facing the stator core 11 is connected to the stop portion 213 thereof, and an extension direction of the stop portion 213 thereof is different from an extension direction of the connecting portion 214 thereof, and the stop portion 213 thereof is configured to abut against the stator core 11 to limit the rotation angle of the rotor assembly 20.

That is, each of the protruding portions 211 comprises two components, such as the stop portion 213 thereof and the connecting portion 214 thereof that extend in different directions, which enriches a structural form of the protruding portions 211, facilitates the protruding portions 211 to quickly extend outward to form a certain distance from the surfaces of the permanent magnets 22, and further facilitates the protruding portions 211 to extend toward limit stop positions of the stator core 11. Therefore, for each of the protruding portions 211, the stop portion 213 thereof and the connecting portion 214 thereof extend in different directions. During the rotation of the rotor assembly 20 relative to the stator assembly 10, the stop portion 213 thereof provided on the connecting portion 214 is able to adjust a position of each of the protruding portions 211 in engagement with the stator core 11, so that the rotor assembly 20 is allowed to stop in an area with greater magnetic resistance in the magnetic circuit and the rotor assembly 20 is avoided lingering in areas with less magnetic resistance. Therefore, during an initial operation of the stator assembly 10 and the rotor assembly 20, the rotor assembly 20 is able to quickly start, with convenient and easy startup, stable rotation, and reduced low-speed jitter.

In some embodiments, as shown in FIGS. 8 and 9, for each of the protruding portions 211, the connecting portion 214 thereof extends toward the stator core along a radial direction substantially parallel to the rotor core 21, and the stop portion 213 thereof extends toward the stator core along a direction forming a certain angle with the radial direction of the rotor core 21, so that each of the protruding portions 211 is allowed to extend outward to spaced apart with the corresponding two adjacent permanent magnets 22 while being able to abut against the stator core 21 at a predetermined position.

In some embodiments, as shown in FIG. 8, the stator core 11 comprises the two winding arms 111. The protruding portions 211 are capable of swinging in an area between the two winding arms 111. During rotation of the rotor assembly 20, each stop portion 213 contacts an end surface of a corresponding one of the winding arms 111 before each connecting portion 214 contacts the end surface of the corresponding one of the winding arms 111. In the embodiments, for each of the protruding portions 211, the connecting portion 214 thereof and the stop portion 213 thereof rotate in the area between the two winding arms 111. Each of the winding arms 111 has a certain length along the circumferential direction of the stator core 11. Each stop portion 213 contacts the end surface of the corresponding one of the winding arms 111 to limit the rotation of the stator core 11 relative to the rotor assembly 20. When achieving the same angular rotation limit, compared to providing the stop portion 213 at another position on each of the protruding portions 211, the arrangement of the stop portion 213 reduces an extension length of the stop portion 213 and facilitates a larger rotation range of the rotor core, so that the rotor core 21 is enabled to rotate within a wider angular range. For each of the protruding portions 211, the stop portion 213 thereof preferentially contacts the end surface of the corresponding one of the winding arms 111. In a case where each connecting portion 214 contacts the end surface of the corresponding one of the winding arms 111 first, each connecting portion 214 and the corresponding one of the winding arms 111 only form a point contact or partial surface contact. A contact area between each stop portion 213 and the end surface of the corresponding one of the winding arms 111 is larger than that of each connecting portion 214, thereby increasing the contact area during the limiting process, making the limit fit more stable. In the embodiments, each stop portion 213 achieves mechanical limit when it contacts the end surface of the corresponding one of the winding arms 111.

Furthermore, as shown in FIG. 8, each of the winding arms 111 comprises the support portion 112. Each support portion 112 is recessed toward the one side of the rotor core 21. A shape of an end surface of each stop portion 213 facing a corresponding support portion 112 is matched with a shape of an end surface of the corresponding support portion 112 facing the stop portion 213. Thus, the contact area between each stop portion 213 and the end surface of the corresponding one of the winding arm s111 is large enough during the abutment process, and the limiting effect is stable enough. When the rotor core 21 rotates to the maximum angle, each stop portion 213 and a corresponding support portion 112 achieve mechanical limiting.

Alternatively, a cross-sectional area of each stop portion 213 along a first direction is not greater than a cross-sectional area of each support portion 112 along the first direction. The first direction is substantially parallel to the axial direction of the rotor assembly 20. Such an arrangement allows each stop portion 213 to be designed to be more compact under a premise of playing a stable and reliable limiting role. The cross-sectional area of each stop portion 213 reduces, which further reduces an impact of each stop portion 213 on the magnetic circuit.

Alternatively, as shown in FIG. 8, each of the winding arms 111 comprises the support portion 112. Each support portion 112 is recessed toward the one side of the rotor core 21. The shape of the end surface of each stop portion 213 facing the corresponding support portion 112 is matched with the shape of the end surface of the corresponding support portion 112 facing the stop portion 213. The cross-sectional area of each stop portion 213 along the first direction is not greater than the cross-sectional area of each support portion 112 along the first direction. The first direction is substantially parallel to the axial direction of the rotor assembly 20. Effects thereof may refer to the embodiments described above, which are not repeatedly described herein.

In some embodiments, as shown in FIGS. 9-10, for each of the protruding portions 211, an included angle is formed between the extension direction of the stop portion 213 thereof and the extension direction of the connecting portion 214 thereof, and the included angle is greater than 0 degrees and not greater than 90 degrees. In the embodiments, a configuration of each connecting portion 211 allows each stop portion 213 to be indirectly connected to the rotor core 21 and further allows each stop portion 213 to extend outward. A distance between the end surface of each stop portion 213 closest to the rotor core 21 and the rotating shaft 24 is greater than a distance between each of the permanent magnets 22 and the rotating shaft 24, which prevents the impact force of each stop portion 213 colliding with the stator core 11 from being directly transferred to the magnet steels 22, thereby reducing a probability of the permanent magnets 22 falling off. The configuration of each stop portion 213 realizes a specific cooperation in the direction of the end surface of the corresponding one of the winding arms 111, which not only facilitates the limiting of each stop portion 213 and the corresponding one of the winding arms 111, but also allows the extension length of each stop portion 213 to be adjusted according to actual needs. Thus, a displacement of each stop portion 213 is required to rotate before each stop portion 213 contacts the corresponding one of the winding arms 111 for limiting. Finally, the rotation angle and a stop position of the rotor assembly 20 are adjusted.

It should be noted that in the present disclosure, each stop portion 213 is shaped like a wing. A shape and an angle of each stop portion 213 are designed based on a desired rotation angle of the rotor assembly and a changing trend of the cogging torque. For example, in a specific embodiment, based on design requirements, the rotation angle of the rotor assembly 20 is determined through simulation, and a mechanical limiting angle of each stop portion 213 must be greater than the rotation angle of the rotor assembly 20. For another example, in another specific embodiment, the changing trend of the cogging torque of the rotor assembly is determined through simulation, and a critical point where the rotor assembly 20 is about to be attracted is found. The mechanical limiting angle of each stop portion 213 is not allowed to exceed the critical point. For another example, a height of each stop portion 213 is primarily determined by a required torsional strength. When the required torsional strength is high, the height of each stop portion 213 is large. When the required torsional strength is low, the height of each stop portion 213 is reduced accordingly. For another example, the shape of each stop portion 213 is primarily determined by the mechanical limiting angle. At the same time, in order to reduce an influence of each stop portion 213 on the magnetic circuit of the rotor assembly 20, while ensuring a strength of the rotor assembly 20, a width of the teeth of the rotor assembly 20 should be reduced as much as possible to reduce the influence of each stop portion 213 on the magnetic circuit of the rotor assembly 20.

In some embodiments, as shown in FIGS. 8-10, for each of the protruding portions 211, along an extension direction parallel to the stop portion 213 thereof, a length of the stop portion 213 thereof is greater than a length of the connecting portion 214 thereof. Therefore, each stop portion 213 forms a limiting fit with the end surface of the corresponding one of the winding arms 111 before each connecting portion 214 contacts the corresponding one of the winding arms 111. The length of each stop portion 213 is adjusted to adjust the position of the rotor assembly 20 relative to the stator assembly 10, thereby effectively preventing the rotor assembly 20 from rotating into an area of lower magnetic resistance in the magnetic circuit. Furthermore, for each of the protruding portions 211, a cross section of the connecting portion 214 thereof parallel to the extension direction of the stop portion 213 thereof is less than a cross section of the stop portion 213 thereof parallel to the extension direction of the stop portion 213 thereof. In other words, each connecting portion 214 is designed to be thin, so that each connecting portion 214 is allowed to maintain a certain distance from the corresponding two adjacent permanent magnets 22 during an extension process. Such an arrangement further reduces a design size and a space occupied by all of the protruding portions 211, thereby minimizing the impact on the magnetic circuit. Furthermore, the specific extension direction and length of each stop portion 213 limit the rotation angle of the rotor assembly 20, thereby preventing the rotor assembly 20 from attaching to the permanent magnets due to large swing angles.

In some embodiments, as shown in FIG. 8, for each of the protruding portions 211, a cross section passing through a geometric center of the stop portion 213 thereof and a rotation center of the rotor core 21 is a symmetry plane of the stop portion 213 thereof, and the stop portion 213 is a symmetrical structure relative to the symmetry plane of the stop portion 213 thereof. In this way, each stop portion 213 is formed into a symmetrical structure, and a rotation center of the rotor assembly 20 is not easily deviated after each stop portion 213 is configured. During the rotation of the rotor assembly 20, when each stop portion 213 stably contacts the end surface of the corresponding one of the winding arms 111 for limiting, and the rotation of the rotor assembly 20 is also stable.

In some embodiments, as shown in FIGS. 8 and 10, for each of the protruding portions 211, a distance between the end surface of the stop portion 213 thereof facing the rotor core 21 and the central axis of the rotor core 21 is greater than the distance between the outer surface of each of the permanent magnets 22 and the central axis of the rotor core 21. Therefore, when each stop portion 213 stably contacts and collides with the stator core 11 of the end surface of the corresponding one of the winding arms 111 for limiting, interference in the permanent magnets 22 is reduced, thereby reducing the probability of the permanent magnets 22 falling off.

In some embodiments, as shown in FIG. 8, a length of each stop portion 213 along the extension direction thereof is not less than an arc length of a concentric arc of the rotor core 21 passing through a distal end of each stop portion 213. Therefore, each stop portion 213 is designed to be long, and during the rotation of the rotor assembly 20, each stop portion 213 is able to contact the corresponding one of the winding arms 111 of the stator core 11 along a rotational path thereof, thereby achieving a collision engagement between each stop portion 213 and the corresponding one of the winding arms 111. Furthermore, by providing each stop portion 213 with a specific structure, when each stop portion 213 collides with the stator core 11 or the corresponding one of the winding arms 111, the rotor assembly 20 is avoided staying in the area with low magnetic resistance in the magnetic circuit.

In some embodiments, as shown in FIG. 8, for each of the protruding portions 211, the stop portion 213 thereof and the connecting portion 214 thereof are integrally formed with the rotor core 21. The connecting portion 214 and the stop portion 213 of each of the protruding portions 211 are integrally formed with the rotor core 21, enhancing structural stability of each connecting portion 214 and each stop portion 213, reducing assembly steps, saving assembly time, lowering assembly difficulty, reducing costs, and improving assembly efficiency. Understandably, in the prior art, the conventional motor commonly uses blocking plates for torsion resistance, and the blocking plates are secured to the rotating shaft by two-component epoxy resin glue, which increases labor costs. The two-component epoxy resin glue further makes production line management and operation difficult. Furthermore, laser welding is adopted to secure the blocking plates to the rotating shaft, which increases equipment investment and labor. Furthermore, the blocking plates are secured to the winding brackets, which are relatively fragile and lack torsional strength. Compared to the prior art, in the embodiments, each of the protruding portion 211 is integrally connected to the rotor core 21, eliminating the need for glue. Such an arrangement simplifies assembly, reduces labor costs, facilitates mass production, and eliminates a need for laser equipment. Instead, each stop portion 213 is enabled to abut against the corresponding one of the winding arms 111 of the stator core 11. Therefore, the rotor assembly 20 has good torsional resistance. When each stop portion 213 abuts against the corresponding one of the winding arms 111, there is hard contact between the rotor core 21 and the stator core 11. The winding brackets have a greater structural strength than plastic winding brackets, making the abutment limit effect more stable and preventing the winding brackets from being misplaced.

In some embodiments, as shown in FIGS. 2 and 3, the rotor core 21 further comprises limiting portions 212 disposed on the outer surface thereof. The limiting portions 212 extend axially along the rotor core 21, and each two adjacent permanent magnets 22 abut against a corresponding one of the limiting portions 212 for positional restraint. In other words, each of the permanent magnets 22 is limited between corresponding two of the limiting portions 212, so that the permanent magnets 22 are circumferentially limited on the rotor core 21, thereby effectively preventing rotation or misalignment.

For instance, the limiting portions 212 are protruded on the outer surface of the rotor core 21. In the embodiments, a limiting space is formed between each two adjacent limiting portions 212, into which a corresponding one of the permanent magnets 22 is placed and limited. Alternatively, the rotor core 21 defines grooves on the outer surface thereof, and groove walls between each two adjacent grooves form the limiting portions 12, and the permanent magnets 22 are respectively positioned within the grooves, which are not limited thereto.

Furthermore, as shown in FIGS. 2-3, a portion of a surface of at least one of the limiting portions 212 extends radially outward from the rotor core 21 to form one group of protruding portions 211. The surfaces of the protruding portions 211 are spaced apart from the surfaces of the permanent magnets 22. In other words, each group of protruding portions 211 is formed on the outer surface of a corresponding one of the limiting portions 212, and each group of protruding portions 211further protrude radially outward from the rotor core 21 toward the stator core 11. Each group of protruding portions 21f does not contact the permanent magnets 22, effectively preventing the two groups of protruding portions 211 from colliding with the stator core 11 and colliding with the permanent magnets 22, thereby preventing the permanent magnets 22 from falling off.

In some embodiments, two groups of protruding portions 211 are provided on two of the limiting portions 212 that are symmetrically disposed along the center plane of the rotor core 21, so that the two groups of protruding portions 211 are symmetrically disposed relative to the center plane of the rotor core 21, and the gravity center of the rotor assembly 20 is located at a geometric center thereof. Therefore, the rotor assembly 20 is subjected to uniform force when rotating. During the rotation of the rotor core 21, the two groups of protruding portions 211 that are symmetrically disposed simultaneously abut against the stator core 11 and rotate, and the two groups of protruding portions 211 are subjected to force, and the rotation of the rotor core 21 is more stable.

In some embodiments, as shown in FIGS. 1, 4, and 5, the motor 100 further comprises an end cover 32. As shown in FIGS. 2 and 3, a through hole 311 is defined in a first end of the motor housing 31, and an opening 312 is defined in a second end of the motor housing 31. The end cover 32 is configured to cover the through hole 311 after the stator assembly 10 and the rotor assembly 20 are mounted in the motor housing 31. The rotor assembly 20 comprises a rotating shaft 24, and the rotor core 21 is connected to the rotating shaft 24. A first end of the rotating shaft 24 is rotatably connected to the stator assembly 10, and a second end of the rotating shaft 24 extends from the opening 312 of the motor housing 31, thereby forming a power output end of the motor. The rotating shaft 24 is then connected to a brush handle of the cleaning element.

In some embodiments, as shown in FIGS. 2 and 3, the motor 100 further comprises two bearings 33 mounted on the rotating shaft 24. An outer portion of a first bearing 33 abuts against the end cover 32, and an outer wall of a second bearing 33 abuts against the motor housing 31. the two bearings 33 ensure smooth rotation of the rotating shaft 24 and prevent the rotating shaft 24 from getting stuck or burning. The two bearings 33 further reduce wear on the motor housing 31 during rotation of the rotor assembly 20 and ensures stable rotation of the rotor assembly 20 relative to the motor housing 31.

The present disclosure further provides an electric toothbrush. The electric toothbrush comprises the cleaning element and the motor 100 described in the aforementioned embodiments. The rotor assembly 20 of the motor 100 comprises the rotating shaft 24 connected to the cleaning element.

It is noted that in the electric toothbrush of the present disclosure, because the rotor core 21 is rotatable stably within the predetermined range, or is rotatable within a wide angle within the predetermined range, the cleaning element connected to the rotor core 21 is able to stably swing and vibrate, rather than merely vibration. Therefore, the cleaning element is able to automatically and stably swing over a large area while cleaning teeth, thereby achieving effortless, efficient, and reliable cleaning of the teeth.

In some embodiments, the brush handle of the cleaning element is sleeved on the rotating shaft 24 to form a stable connection, so that the motor 100 is allowed to effectively drive the cleaning element to vibrate and swing.

The above are only optional embodiments of the present disclosure, but the protection scope of the present disclosure is not limited thereto. Any changes or substitutions that can be easily conceived by those skilled in the art within the technical scope disclosed in the present disclosure shall be fall in the protection scope of the present disclosure. Therefore, the protection scope of the present disclosure should be determined by the protection scope of the claims.

What is claimed is:

1. A motor of an electric toothbrush, comprising:
a motor housing;
a stator assembly fixedly disposed in the motor housing; and
a rotor assembly;
wherein the stator assembly comprises a stator core;
wherein the rotor assembly is disposed in a mounting cavity of the stator assembly, and the rotor assembly comprises a rotor core, permanent magnets and at least one protruding portion; the at least one protruding portion is a protrusion disposed on an outer surface of the rotor core;
wherein the permanent magnets are disposed at intervals in a circumferential direction of the rotor core.

2. The motor according to claim 1, wherein the at least one protruding portions, at least one group of protruding portions is disposed between corresponding two adjacent permanent magnets, the at least one group of protruding portions extends from a surface of the rotor core in a direction away from a central axis of the rotor core.

3. The motor according to claim 1, wherein a distance between an end surface of the at least one protruding portion facing the stator core and the central axis of the rotor core is greater than a distance between an outer surface of each of the permanent magnets and the central axis of the rotor core.

4. The motor according to claim 2, wherein the permanent magnets are evenly disposed in the circumferential direction of the rotor core, the at least one group of protruding portions extends along an axial direction of the rotor core, and a length of the at least one group of protruding portions along the axial direction of the rotor core is not greater than a length of each of the permanent magnets along the axial direction of the rotor core.

5. The motor according to claim 4, wherein the permanent magnets comprise four permanent magnets evenly disposed at equal angles along the circumferential direction of the rotor core, the at least one group of protruding portions comprises two groups of protruding portions, and each group of the protruding portions is disposed between the corresponding two adjacent permanent magnets of the four permanent magnets.

6. The motor according to claim 5, wherein the two groups of protruding portions are symmetrically disposed relative to a center plane of the rotor core.

7. The motor according to claim 2, wherein the at least one group of protruding portions comprises at least two protruding portions disposed at intervals.

8. The motor according to claim 4, wherein when the length of the at least one group of protruding portions along the axial direction of the rotor core is less than the length of each of the permanent magnets along the axial direction of the rotor core, a midpoint of the at least one group of protruding portions along the axial direction of the rotor core coincides with a midpoint of the rotor core along the axial direction.

9. The motor according to claim 1, wherein an outer surface of the at least one protruding portions is spaced apart from outer surfaces of the permanent magnets.

10. The motor according to claim 1, wherein the at least one protruding portion comprises a stop portion and a connecting portion, one end of the connecting portion facing the stator core is connected to the stop portion, an extension direction of the stop portion is different from an extension direction of the connecting portion, and the stop portion is configured to abut against the stator core to limit a rotation angle of the rotor assembly.

11. The motor according to claim 10, wherein the stator core comprises two winding arms, the at least one protruding portion is capable of swinging in an area between the two winding arms, and during rotation of the rotor assembly, the stop portion contacts an end surface of a corresponding one of the winding arms before the connecting portion contacts the end surface of the corresponding one of the winding arms.

12. The motor according to claim 11, wherein each of the winding arms comprises a support portion, each support portion is recessed toward one side of the rotor core, and a shape of an end surface of each stop portion facing a corresponding support portion is matched with a shape of an end surface of the corresponding support portion facing the stop portion; and/or
a cross-sectional area of the stop portion along a first direction is not greater than a cross-sectional area of each support portion along the first direction, and the first direction is substantially parallel to an axial direction of the rotor assembly.

13. The motor according to claim 10, wherein an included angle is formed between the extension direction of the stop portion and the extension direction of the connecting portion, and the included angle is greater than 0 degrees and not greater than 90 degrees.

14. The motor according to claim 10, wherein along an extension direction parallel to the stop portion, a length of the stop portion is greater than a length of the connecting portion.

15. The motor according to claim 10, wherein a cross section passing through a geometric center of the stop portion and a rotation center of the rotor core is a symmetry plane of the stop portion, and the stop portion is a symmetrical structure relative to the symmetry plane of the stop portion.

16. The motor according to claim 10, wherein a distance between an end surface of the stop portion facing the rotor core and the central axis of the rotor core is greater than a distance between the outer surface of each of the permanent magnets and the central axis of the rotor core.

17. The motor according to claim 10, wherein a length of the stop portion along the extension direction thereof is not less than an arc length of a concentric arc of the rotor core passing through a distal end of the stop portion.

18. The motor according to claim 10, wherein the stop portion and the connecting portion are integrally formed with the rotor core.

19. The motor according to claim 1, wherein the stator assembly further comprises two groups of coils, two winding arms are respectively disposed on opposite sides of an inner surface of the stator core, the two winding arms are one-to-one wound around the two groups of coils;
wherein the at least one protruding portion extends toward the inner surface of the stator core between the two winding arms; and when the rotor core rotates to a maximum angle, the at least one protruding portion abuts against a corresponding one of the winding arms;
wherein each of the winding arms comprises a support portion, the support portion thereof is bending and recessed towards one side of the rotor core, and the support portion thereof is configured to limit a maximum radial displacement of each of the permanent magnets when the permanent magnets rotate.

20. An electric toothbrush, comprising:
a cleaning element; and
a motor;
wherein the motor comprises a motor housing, a stator assembly fixedly disposed in the motor housing, and a rotor assembly;
wherein the stator assembly comprises a stator core;
wherein the rotor assembly is disposed in a mounting cavity of the stator assembly, and the rotor assembly comprises a rotor core, permanent magnets and at least one protruding portion;
wherein the permanent magnets are disposed at intervals in a circumferential direction of the rotor core.
